(19) United States
(12) Patent Application Publication
(10) Pub. No.: US 2010/0318909 A1
(43) Pub. Date: Dec. 16, 2010

(54) CONTAINER DISPLAY CONTROL DEVICE AND PROGRAM FOR THE SAME

(76) Inventor: Nobuya TACHIMORI, Neyagawa-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/713,354

(22) Filed: Feb. 26, 2010

(30) Foreign Application Priority Data
Jun. 10, 2009 (JP) 2009-138901

(51) Int. Cl. G06F 3/01

(52) U.S. Cl. 715/716

(57) ABSTRACT

A container display control device comprising: a container title acquiring unit that acquires one or more container titles from a server, the one or more container titles relating to respective one or more containers in a tier immediately under a top tier container; a registration unit to which identification information is registered in advance, the identification information being for indicating that a category of a container is a first category; a category determination unit that determines, for each container in the tier immediately under the top tier container, whether or not the container title includes the identification information registered to the registration unit and indicating that the container is of the first category; and a setting unit that sets a container whose title includes the identification information as the top tier container, the identification information indicating that the container is of the first category.

### BACKGROUND OF THE INVENTION

1. Field of the Invention

The present invention relates to a container display control device capable of displaying containers in a plurality of tiers for searching contents by a user operation in a display device, and a program for such a device.

2. Description of the Related Art

A typical content playback apparatus such as an AV amplifier is able to acquire and play a content recorded in a server, for example, in a streaming manner. In order to search for a desired content that the user wishes to play out of a number of contents recorded in the server, the AV amplifier acquires container information from the server, and causes a display device to display a list of the containers. The containers respectively represent nodes in a tree for searching for the contents recorded in the server shown in FIG. 2, and are often referred to as folders. The container in a top tier is referred to as a root container, and three containers respectively titled as “all music”, “all videos”, and “all images” are included in a tier immediately under the root container. It is possible to search for an music content when moving down to tiers under the “all music” container, a video content when moving down to tiers under the “all videos” container, and an image content when moving down to tiers under the “all images” container.

First of all, the AV amplifier acquires container information regarding the containers in the tier immediately under the root container from the server, and causes the display device to display the titles of the containers in the tier immediately under the root container as shown in FIG. 6A. A container is selected by moving a displayed cursor by a user operation to the title of the container and selecting the title, and the AV amplifier further acquires container information regarding containers in a tier immediately under the selected container from the server, and displays titles of the containers. For example, if the “all music” container is selected, an “all contents” container, an “all artists” container, and an “all albums” container are displayed as shown in FIG. 6B. By repeating the selection of the container in this manner, a list of searchable contents in the selected container is finally displayed, and a user is able to search for a desired content.

Here, the AV amplifier is often able to play only audio contents, for example, and not able to play video contents or image contents. In this case, when the “all videos” container is selected in FIG. 6A, a list of video contents is finally displayed. However, as the AV amplifier is not able to play the video contents, information indicating that the video contents included in the list cannot be played is displayed. As a result, the user has to return to the list of the containers in the tier immediately under the root container shown in FIG. 6A, and then has to select the “all music” container again. This poses a problem that the operations are extremely cumbersome and it takes time to search for a desired content.

In order to solve this problem, the playback apparatus disclosed in Japanese Patent No. 4229184 has been proposed. The Patent No. 4229184 describes that the audio playback apparatus 2 is provided with the list acquisition unit 210 that accesses the root container of the server apparatus and acquires the tags (container attributes) respectively assigned to the containers under the root container from the server apparatus, the tag analysis unit 230 that determines the presence of the container that includes an audio content based on the tags that the list acquisition unit 210 has acquired, and the tier display unit 240 that displays only the tier of the containers that has been determined to include the audio content by the tag analysis unit 230. However, there still is a problem that it is not possible to determine the presence of the container that includes an audio content when a tag assigned to the container cannot be acquired from the server.

### SUMMARY OF THE INVENTION

An object of the present invention is to provide a container display control device capable of displaying containers in a tiered structure in order to search, based on a user operation, for a desired content to be played by a content playback apparatus capable of playing contents only of a first category, the desired content being one of a plurality of contents of a plurality of categories recorded in a server, with which erroneous selection of a container of contents that cannot be played by the content playback apparatus due to the user operation can be prevented by determining a category of a container without using a tag of the container.

According to a preferred embodiment of the present invention, a container display control device comprising: a container title acquiring unit that acquires one or more container titles from a server, the one or more container titles relating to respective one or more containers in a tier immediately under a top tier container; a registration unit to which identification information is registered in advance, the identification information being for indicating that a category of a container is a first category; a category determination unit that determines, for each container in the tier immediately under the top tier container, whether or not the container title includes the identification information registered to the registration unit and indicating that the container is of the first category; and a setting unit that sets a container whose title includes the identification information as the top tier container, the identification information indicating that the container is of the first category.

When there is only one container whose category is the first category among the one or more containers in the tier immediately under the top tier container, the container of the first category is set as the top tier container. Accordingly, a list of the one or more containers in the tier immediately under the container of the first category are first displayed, instead of one or more containers in the original tier immediately under the top tier container. Therefore, even when the one or more containers in the original tier immediately under the top tier container include a container for searching contents that cannot be played by the content playback apparatus, it is possible to prevent such a container from being selected by the user operation. Further, as it is determined whether or not the category of the container is the first category by determining whether or not the identification information (text strings, for example) for indicating that the container is of the first category is included in the title of the container, it is possible to determine the category of the container even when the tag of each container cannot be acquired. This is because the title of the container can always be acquired as the title is required to display the container.

In the preferred embodiment of the present invention, the container display control device further comprising: a determining unit that determines whether or not the one or more containers in the tier immediately under the top tier container include only one container whose title includes the identification information indicating that the container is of the first category, wherein when only one container whose title includes the identification information indicating that the container is of the first category is included, the setting unit set the container whose title includes the identification information indicating that the container is of the first category as the top tier container.

According to another preferred embodiment of the present invention, a container display control device comprising a container title acquiring unit that acquires one or more container titles from a server, the one or more container titles relating to respective one or more containers in a tier immediately under a top tier container; a registration unit to which identification information is registered in advance, the identification information being for indicating that a category of a container is a first category; a category determination unit that determines, for each container in the tier immediately under the top tier container, whether or not the container title includes the identification information registered to the registration unit and indicating that the container is of the first category; and a display control unit that displays a list of one or more containers in the tier immediately under the container whose title includes the identification information indicating that the container is of the first category in a display device, without displaying a list of the one or more containers in the tier immediately under the top tier container in the display device.

The list of the one or more containers in the tier immediately under the container of the first category is first displayed, instead of one or more containers in the original tier immediately under the top tier container. Therefore, even when the one or more containers in the original tier immediately under the top tier container include a container for searching contents that cannot be played by the content playback apparatus, it is possible to prevent such a container from being selected by the user operation. Further, as it is determined whether or not the category of the container is the first category by determining whether or not the identification information (text strings, for example) for indicating that the container is of the first category is included in the title of the container, it is possible to determine the category of the container even when the tag of each container cannot be acquired. This is because the title of the container can always be acquired as the title is required to display the container.

In the preferred embodiment of the present invention, the container display control device further comprising: a determining unit that determines whether or not the one or more containers in the tier immediately under the top tier container include only one container whose title includes the identification information indicating that the container is of the first category, wherein when only one container whose title includes the identification information indicating that the container is of the first category is included, the display control unit displays the list of the one or more containers in the tier immediately under the container whose title includes the identification information indicating that the container is of the first category in the display device, without displaying the list of the one or more containers in the tier immediately under the top tier container in the display device.

In the preferred embodiment of the present invention, when more than one container whose title includes the identification information indicating that the container is of the first category is included, the display control unit displays the list of the one or more containers in the tier immediately under the top tier container in the display device.

For example, when there are two containers of the first category, a desired container can be selected out of the two containers of the first category through which a content that can be played is searched by the user operation.

In the preferred embodiment of the present invention, identification information for indicating that a category of a container is a second category is registered, in advance, in the registration unit, the category determination unit further determines, for each container in the tier immediately under the top tier container, whether or not the container title includes the identification information registered to the registration unit and indicating that the container is of the second category, and when more than one container whose title includes the identification information indicating that the container is of the first category is included, the display control unit displays a list of containers excluding a container whose title includes the identification information indicating the container is of the second category out of the one or more containers in the tier immediately under the top tier container.

For example, when there are two containers of the first category and when there is one container of the second category, the only two containers of the first category are displayed and the one container of the second category is not displayed. Therefore, a desired container can be selected out of the two containers of the first category through which a content that can be played is searched by the user operation, and it is possible to prevent a container of the second category through which a content that cannot be played is searched from being erroneously selected.

### BRIEF DESCRIPTION OF THE DRAWINGS

FIG. 1 is a block diagram illustrating an AV amplifier 100 and a server 200 according to a preferred embodiment of the present invention;

FIG. 2 shows a tree including containers in a plurality of tiers;

FIG. 3 is a table showing container information of the containers in a tier immediately under a root container;

FIG. 4 is a table showing lists of text strings;

FIG. 5 shows a tree in which a container whose category is audio is set as the root container;

FIG. 6A and FIG. 6B are illustrations respectively showing lists of containers in the tier immediately under the root container, and a list of containers in a tier immediately under “all music” container;

FIG. 7 is a flow chart showing a process carried out by a microcomputer 1;

FIG. 8 is a table showing container information of the containers in the tier immediately under the root container;

FIG. 9 is an illustration showing a list of containers in the tier immediately under the root container;

FIG. 10 is a flow chart showing a process carried out by the microcomputer 1; and

FIG. 11 is an illustration showing a list of containers in the tier immediately under the root, with a container whose category is video or image undisplayed.

### DETAILED DESCRIPTION OF THE PREFERRED EMBODIMENTS

The following specifically describes preferred embodiments according to the present invention with reference to the drawing, but the present invention is not limited to these embodiments.

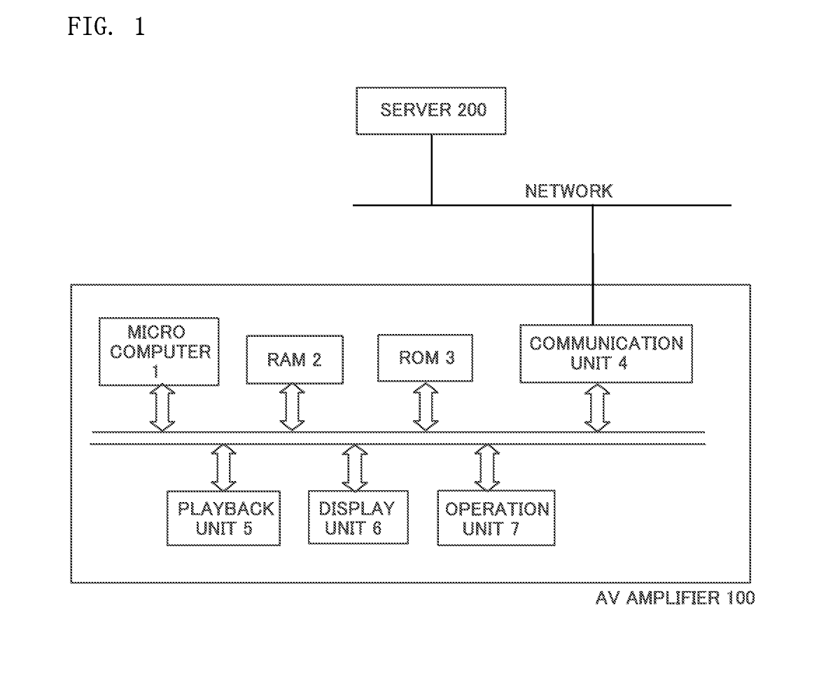

FIG. 1 is a block diagram illustrating a content playback apparatus (hereinafter referred to as the AV amplifier) 100 according to the preferred embodiment of the present invention. The AV amplifier 100 is connectable to a server 200 through an arbitrary network or telecommunication line such as the Internet or an LAN, and acquires a content recorded in the server 200 in a streaming manner and plays the content. The server 200 records the contents of a plurality of categories. The categories refer to types of contents such as audio contents, video contents, and image contents. Out of the contents of the plurality of categories recorded in the server 200, the AV amplifier 100 is only able to play contents of a first category and is not able to play contents of one or more second categories. In this example, the first category is for audio contents, and the second categories are for video contents and image contents, respectively.

The AV amplifier 100 is provided with a control unit such as a microcomputer 1, a RAM 2, a ROM 3, a communication unit 4, a playback unit 5, a display unit 6, and an operation unit 7.

The microcomputer 1 reads operation programs (including a container display control program) for the AV amplifier 100 that are stored in the ROM 3 to the RAM 2 and executes the programs, thereby realizing processes as will be described later. The communication unit 4 communicates with the server 200 through the network, and transmits or receives commands to or from the server 200, or acquires a content or container information from the server 200. The playback unit 5 plays (such as decoding, D/A converting, and amplifying) the content acquired from the server 200. A loudspeaker is connected to the playback unit 5, and sound is played through the loudspeaker. The display unit 6 displays such as a list of containers or contents, or generates an OSD screen of the list and causes an externally connected display device to display the screen. The operation unit 7 is for accepting a user operation, configured as such as an operation button or a remote control.

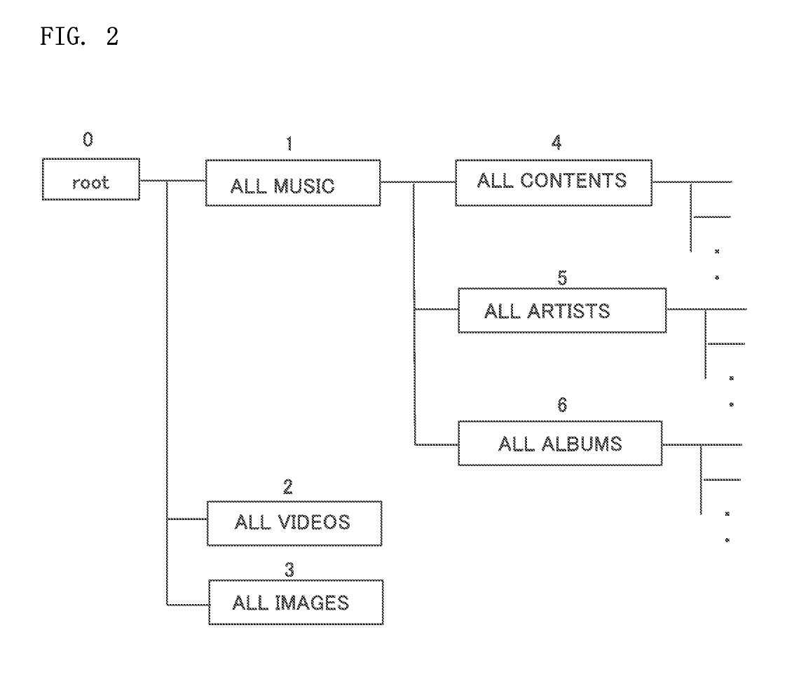

FIG. 2 shows a tree including containers in a plurality of tiers for searching the contents of the plurality of categories recorded in the server 200. A container in a top tier is referred to as a root container. Containers in a tier immediately under the root container belong to respective categories similarly to the contents. Specifically, a container whose category is audio (first category) is a container for searching for audio contents, a container whose category is video (second category) is a container for searching for video contents, a container whose category is image (second category) is a container for searching for image contents.

Referring to FIG. 2, three containers titled as “all music”, “all videos”, and “all images” are included in the tier immediately under the root container. While details will be described later, the category of “all music” is for audio and it is possible to search through audio contents by moving down to a lower tier. The category of “all videos” is for video and it is possible to search through video contents by moving down to a lower tier. The category of “all images” is for image and it is possible to search through image contents by moving down to a lower tier. A number of the tier immediately under the root tier is not limited to three, and can be one or two.

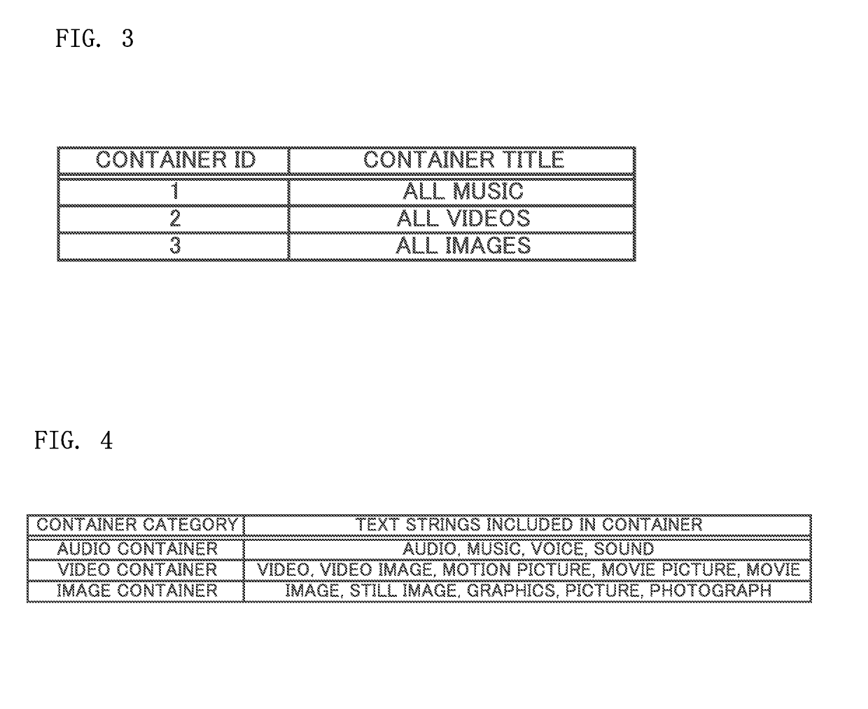

When an instruction to display a screen for searching through the contents is inputted by the user operation, the microcomputer 1 requests the server 200 for the container information of the containers in the tier immediately under the root container and acquires the information. FIG. 3 is a table showing the container information. The container information includes container IDs and container titles. The container IDs are identification information for uniquely identifying the containers, and the container titles are titles of the containers displayed in the list of the containers.

The microcomputer 1 determines the category of one or more containers in the tier immediately under the root container, and then determines if a number of containers whose category is audio is just one. Examples of the method of determining the category of a container include the following methods.

Specifically, the category of a container is determined by determining whether or not predetermined identification information is included in a title of the container. Examples of the predetermined identification information include such as a, predetermined text string, number, symbol, and figure, and predetermined text strings are used in this example. The ROM 3 stores a list of text strings as shown in FIG. 4. Text strings to be included in the title of the container of the category are registered to the list of text strings in association with the category of the container. Accordingly, if the title of the container includes a text string such as audio, sound, voice or music (for determining that the category is audio), the category of the container is determined to be audio. If the title of the container includes a text string such as video, video image, motion picture, movie picture, or movie (for determining that the category is video), the category of the container is determined to be video. If the title of the container includes a text string such as image, still image, graphics, picture, or photograph (for determining that the category is image), the category of the container is determined to be image. If the title of the container does not include any of the text string registered to the lists of text strings, the container can be determined to be a container of another category.

For example, in a case of the containers in the tier immediately under the root tier as shown in FIG. 2 and FIG. 3, when the category of the container is determined based on the above conditions, the category of a container whose title is “all music” is audio, the category of a container whose title is “all videos” is video, and the category of a container whose title is “all images” is image.

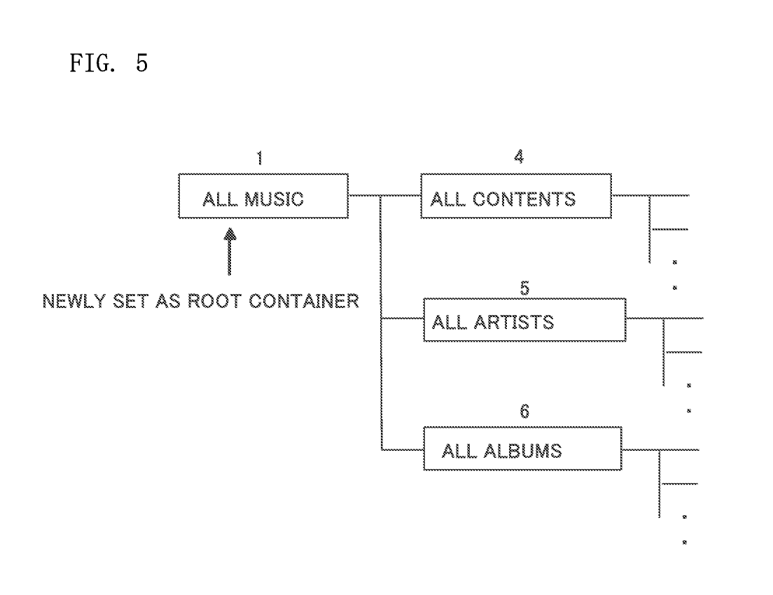

When the number of containers whose category is audio is just one, the microcomputer 1 saves the container whose category is audio in the RAM 2 and newly sets the container as the root container (a container in the top tier). Specifically, the microcomputer 1 saves a container ID of the container whose category is audio in the RAM 2. That is, in the case shown in FIG. 2, the microcomputer 1 newly sets the container whose title is “all music” as the root container, and the containers are handled as if only the containers under the “all music” container are present in a tree for searching through the contents recorded in the server 200 as shown in FIG. 5 for the AV amplifier 100.

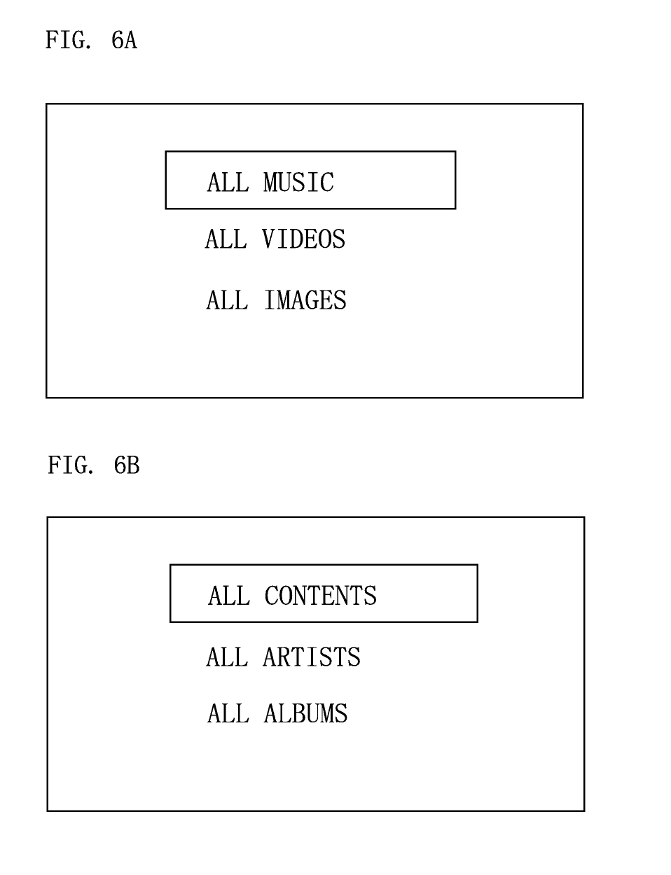

As a result, the microcomputer 1 does not display the list of the containers in the tier immediately under the root container, automatically selects the container whose category is audio, and acquires the container information of the containers in the tier immediately under the container whose category is audio from the server 200. Then, the microcomputer 1 displays the list of the containers in the tier immediately under the container whose category is audio. Conventionally, in the case of the tree as shown in FIG. 2, the containers in the tier immediately under the root container used to be displayed as shown in FIG. 6A, and a container whose category is video or image used to be also selectable even though the AV amplifier 100 cannot play the video content and the image content.

On the other hand, in this embodiment, as the “all music” container whose category is audio is set as the root container as shown in FIG. 5, an “all contents” container, an “all artists” container, and an “all albums” container that are the containers in the tier immediately under the “all music” container are displayed as shown in FIG. 6B. Further, even if the user operates to return to an upper tier, the original list of containers in the tier immediately under the root container (see FIG. 6A) is not displayed. Therefore, a container whose category is video or image will not be wrongly selected by the user operation. Note that a number of the containers in the tier immediately under the “all music” container whose category is audio is not limited to three, and can be one or two.

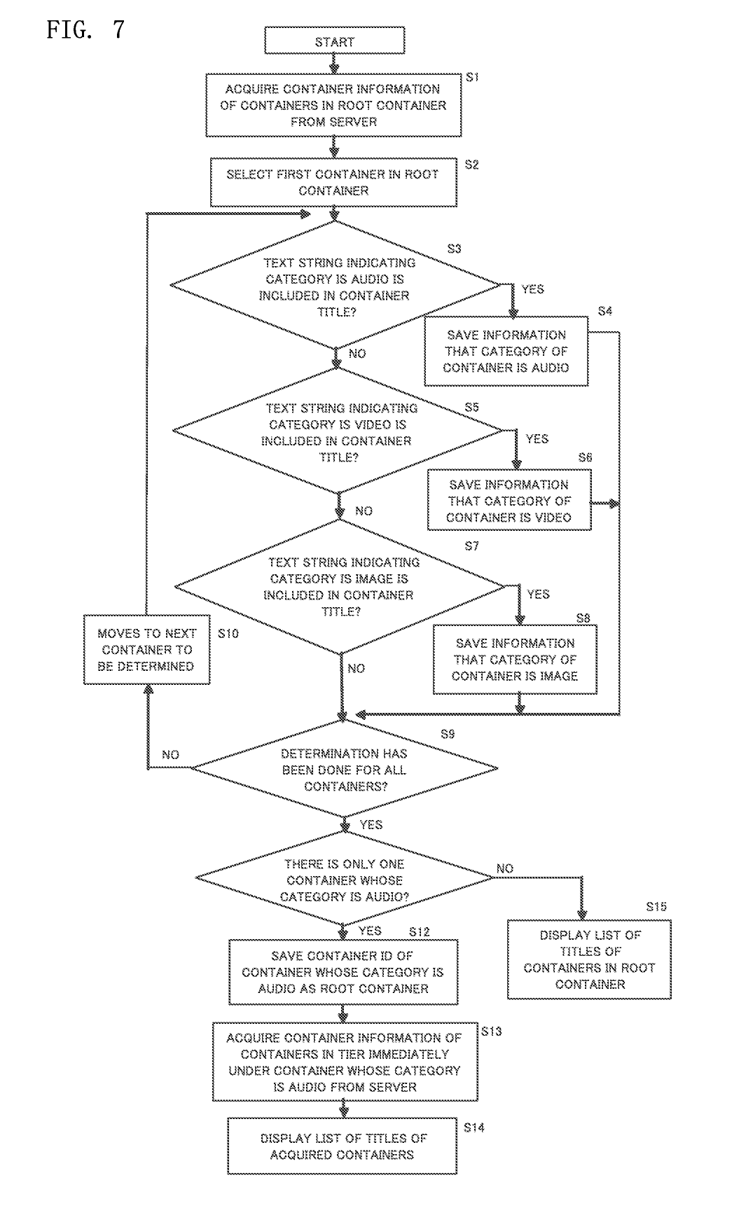

FIG. 7 is a chart showing a process carried out by the microcomputer 1 of this embodiment. When an instruction to display a screen for searching for the contents is inputted by the user operation, the microcomputer 1 requests the server 200 for the container information of the containers in the tier immediately under the root container shown in FIG. 3 and acquires the container information (S1). The microcomputer 1 sequentially checks the categories of the containers in the container information (S2 to S10). First, the microcomputer 1 selects a first container (here, a container whose container ID is 1) in the container information (S2).

The microcomputer 1 reads a title of the selected container from the container information, and determines whether or not the title includes a text string in FIG. 4 with which the category of the container is determined to be audio (such as audio, music, voice, and sound) (S3). If any of such text strings is included in the title (YES in S3), the microcomputer 1 saves information that the category of the container is audio in the RAM 2 (S4). For example, in FIG. 3, as the container whose container ID is 1 includes a text string music in its title, it is determined that the category of this container is audio, and this information is saved in the RAM 2. Then the process proceeds to S9.

In S9, the microcomputer 1 determines whether or not the categories of all the containers in the container information in FIG. 3 have been determined (S9). Here, as the determination of the category has not been done for all of the containers (NO in S9), a determination target moves to a container whose container ID is 2 as the next container (S10), and then the process returns to S3.

A title of the container whose container ID is 2 does not include any text string with which the category of the container is determined to be audio (such as audio, music, voice, and sound) (NO in S3). The microcomputer 1 determines whether or not the title includes a text string with which the category of the container is determined to be video (such as video, video image, motion picture, movie picture, and movie) (S5). If any of such text strings is included in the title (YES in S5), the microcomputer 1 saves information that the category of the container is video in the RAM 2 (S6). For example, in FIG. 3, as the container whose container ID is 2 includes a text string video in its title, it is determined that the category of this container is video, and this information is saved in the RAM 2. Then the process proceeds to S9.

In S9, as the determination of the category has not yet been done for all of the containers (NO in S9), the determination target moves to a container whose container ID is 3 as the next container (S10), and then the process returns to S3.

A title of the container whose container ID is 3 does not include any text string with which the category of the container is determined to be audio (such as audio, music, voice, and sound) (NO in S3). In addition, the title of the container whose container ID is 3 does not include any text string with which the category of the container is determined to be video (such as video, video image, motion picture, movie picture, and movie) (NO in S5). The microcomputer 1 determines whether or not the title includes a text string with which the category of the container is determined to be image (such as image, still image, graphics, picture, and photograph) (S7). If any of such text strings is included in the title (YES in S7), the microcomputer 1 saves information that the category of the container is image in the RAM 2 (S8). For example, in FIG. 3, as the container whose container ID is 3 includes a text string image in its title, it is determined that the category of this container is image, and this information is saved in the RAM 2. Then the process proceeds to S9.

In S9, as it is determined that the determination of the category has been done for all of the containers (YES in S9), the microcomputer 1 determines whether or not there is only one container whose category is audio (S11). In the example shown in FIG. 3, only the category of the container whose container ID is 1 is audio (YES in S11). Accordingly, the microcomputer 1 newly sets the only one container whose category is audio (here, the container whose container ID is 1) as the root container, and saves the container ID of this container in the RAM 2 (S12). As a result, when searching through the contents in the server 200 in the subsequent process, as shown in FIG. 5, the contents are searched based on a tree in which the container whose category is audio (the container whose container ID is 1) is set as the root container.

The microcomputer 1 requests the server 200 for container information of containers in the tier immediately under the container whose container ID is 1 newly set as the root container, and acquires the container information (S13). The container information includes information of containers whose container IDs are 4-6 (the containers whose titles are “all contents”, “all artists”, and “all albums”) in a tree shown in FIG. 5. The microcomputer 1 reads the titles of the containers in the acquired container information, and displays the titles in the display unit (S14). In this case, as shown in FIG. 6B, the “all contents”, the “all artists”, and the “all albums” containers in the tier immediately under the “all music” container are displayed and in a state selectable by the user operation.

As described above, if there is only one container whose category is audio out of the containers in the tier immediately under the root container, the tier immediately under this container is firstly displayed. Accordingly, it is possible to address the problem of requiring longer time for search because of erroneous selection of a container whose category is video or image by the user operation.

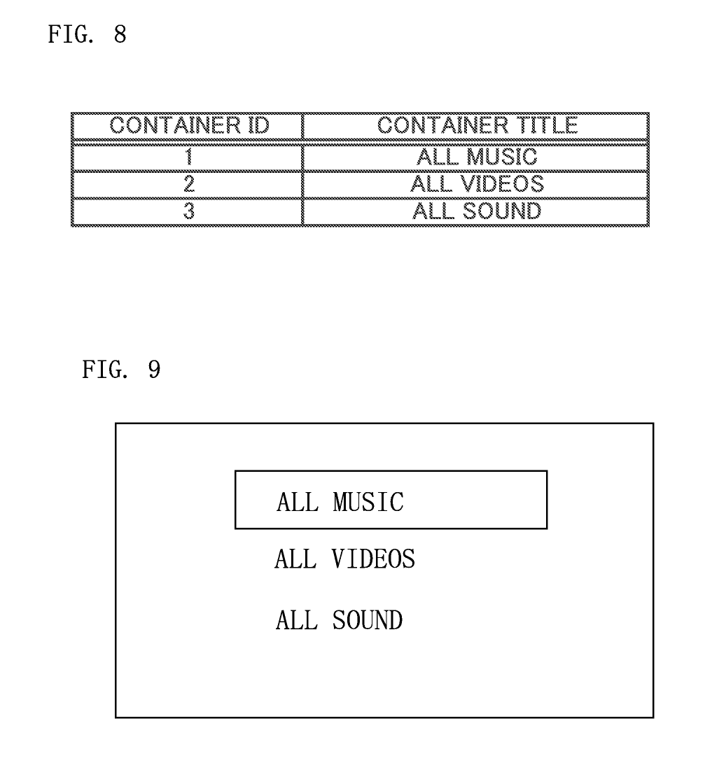

The following describes a case in which, in S2, information as shown in FIG. 8 is acquired as the container information of the containers in the tier immediately under the root container. As the container whose container ID is 1 includes a text string music in its title (YES in S3), the information that the category of the container is audio is saved (S4). As the container whose container ID is container ID is 2 includes a text string video in its title (YES in S5), the information that the category of the container is video is saved (S6). As the container whose container ID is container ID is 3 includes a text string sound in its title (YES in S3), the information that the category of the container is audio is saved (S4).

Therefore, in S11, it is determined that there are two containers whose category is audio (NO in S11). At this time, the microcomputer 1 displays the titles of the containers in the tier immediately under the root container (“all music”, “all videos”, and “all sound”) as shown in FIG. 9 in the display unit. That is, the original root container is maintained as the root container, and the contents are searched according to the tree shown in FIG. 2. Accordingly, it is possible to select desired one of the “all music” and the “all sound” containers whose category is audio by the user operation, and to display the containers in the tier immediately under the selected container. The process is carried out in this manner because, if one of the two containers whose category is audio is automatically selected and the selected container is newly set as the root container, it is not possible to search through the contents in the other container in which the audio contents can be searched.

It should be noted that the titles of the containers in the tier immediately under the root container are also displayed in the display unit, as described above, even when there is no container whose category is audio. That is, the original root container is maintained as the root container, and the contents are searched according to the tree shown in FIG. 2. Further, according to the process shown in FIG. 7, the steps of S5 to S8 are not technically required. In other words, whether the category of the container is video or image can remain unknown, as long as it is possible to determine whether or not the category of the container is audio.

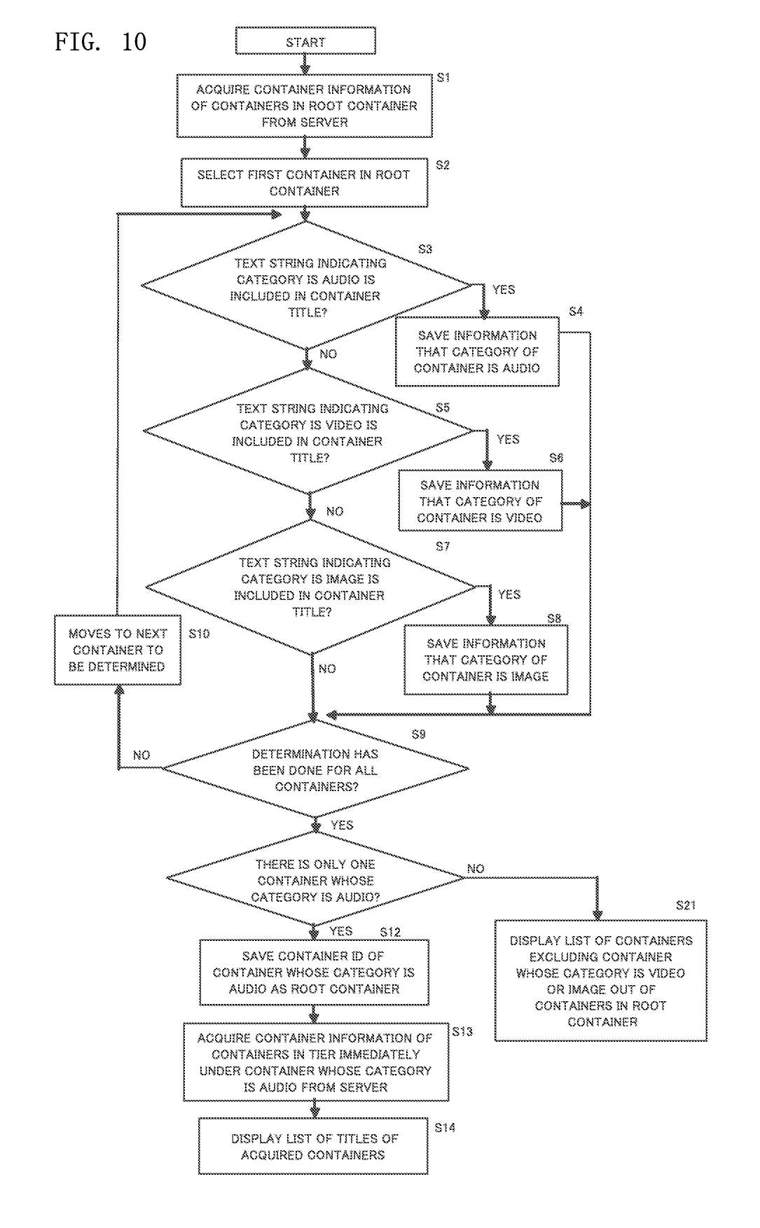

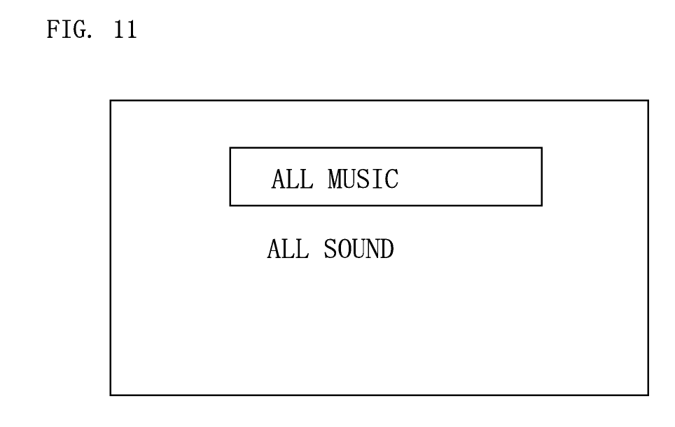

FIG. 10 is a chart showing a process carried out by the microcomputer 1 of another embodiment. As compared to FIG. 7, S15 is replaced by S21. Further, unlike FIG. 7, the steps of S5 to S8 are required. The following describes a case in which, in S2, information as shown in FIG. 8 is acquired as the container information of the containers in the tier immediately under the root container. As the container whose container ID is 1 includes a text string music in its title (YES in S3), the information that the category of the container is audio is saved (S4). As the container whose container ID is container ID is 2 includes a text string video in its title (YES in S5), the information that the category of the container is video is saved (S6). As the container whose container ID is 3 includes a text string sound in its title (YES in S3), the information that the category of the container is audio is saved (S4).

Therefore, in S11, it is determined that there are two containers whose category is audio (NO in S11). At this time, the microcomputer 1 does not display the titles of the containers whose category is video or image out of the containers in the tier immediately under the root container (“all music”, “all videos”, and “all sound”) and displays only the remaining containers as shown in FIG. 11 in the display unit. That is, only the “all music” and the “all sound” containers are displayed. Accordingly, it is possible to select desired one of the “all music” and the “all sound” containers whose category is audio by the user operation, and to display the containers in the tier immediately under the selected container. Further, as the containers whose category is video or image (the “all videos” containers) are not displayed, it is possible to prevent the problem of requiring longer time for searching for a desired content because of erroneous selection of a container whose category is video or image by the user operation.

While the preferred embodiments according to the present invention have been described in the above, the present invention is not limited to these embodiments. The first category can be for video contents, and the second category can be for audio contents and image contents. Further, the category can be for files such as text files or files used for PC applications (such as MS-WORD files, MS-EXEL files, and PDF files). Moreover, the container display control device is not limited to the AV amplifier 100, and can be applied as various products such as television receivers, personal computers, mobile phones, portable audio-video players, gaming machines, and network audio-video clients. The present invention can also be provided as a computer program for operating the above container display control device or as a recording medium in which such a computer program is recorded.

What is claimed is:

1. A container display control device comprising:
a container title acquiring unit that acquires one or more container titles from a server, the one or more container titles relating to respective one or more containers in a tier immediately under a top tier container;
a registration unit to which identification information is registered in advance, the identification information being for indicating that a category of a container is a first category;
a category determination unit that determines, for each container in the tier immediately under the top tier container, whether or not the container title includes the identification information registered to the registration unit and indicating that the container is of the first category; and
a setting unit that sets a container whose title includes the identification information as the top tier container, the identification information indicating that the container is of the first category.

2. The container display control device according to claim 1, further comprising:
a determining unit that determines whether or not the one or more containers in the tier immediately under the top tier container include only one container whose title includes the identification information indicating that the container is of the first category, wherein
when only one container whose title includes the identification information indicating that the container is of the first category is included, the setting unit set the container whose title includes the identification information indicating that the container is of the first category as the top tier container.

3. A container display control device comprising:
a container title acquiring unit that acquires one or more container titles from a server, the one or more container titles relating to respective one or more containers in a tier immediately under a top tier container;
a registration unit to which identification information is registered in advance, the identification information being for indicating that a category of a container is a first category;
a category determination unit that determines, for each container in the tier immediately under the top tier container, whether or not the container title includes the identification information registered to the registration unit and indicating that the container is of the first category; and
a display control unit that displays a list of one or more containers in the tier immediately under the container whose title includes the identification information indicating that the container is of the first category in a display device, without displaying a list of the one or more containers in the tier immediately under the top tier container in the display device.

4. The container display control device according to claim 3, further comprising:
a determining unit that determines whether or not the one or more containers in the tier immediately under the top tier container include only one container whose title includes the identification information indicating that the container is of the first category, wherein
when only one container whose title includes the identification information indicating that the container is of the first category is included, the display control unit displays the list of the one or more containers in the tier immediately under the container whose title includes the identification information indicating that the container is of the first category in the display device, without displaying the list of the one or more containers in the tier immediately under the top tier container in the display device.

5. The container display control device according to claim 4, wherein
when more than one container whose title includes the identification information indicating that the container is of the first category is included, the display control unit displays the list of the one or more containers in the tier immediately under the top tier container in the display device.

6. The container display control device according to claim 4, wherein
identification information for indicating that a category of a container is a second category is registered, in advance, in the registration unit,
the category determination unit further determines, for each container in the tier immediately under the top tier container, whether or not the container title includes the identification information registered to the registration unit and indicating that the container is of the second category, and
when more than one container whose title includes the identification information indicating that the container is of the first category is included, the display control unit displays a list of containers excluding a container whose title includes the identification information indicating the container is of the second category out of the one or more containers in the tier immediately under the top tier container.

7. A container display control program causing a computer to perform the steps of:
acquiring one or more container titles from a server, the one or more container titles relating to respective one or more containers in a tier immediately under a top tier container;
determining, for each container in the tier immediately under the top tier container, whether or not the container title includes the identification information registered to a registration unit and indicating that the container is of a first category, the registration unit to which identification information is registered in advance, the identification information being for indicating that a category of a container is the first category; and
setting a container whose title includes the identification information as the top tier container, the identification information indicating that the container is of the first category.

8. A container display control program causing a computer to perform the steps of:
acquiring one or more container titles from a server, the one or more container titles relating to respective one or more containers in a tier immediately under a top tier container;
determining, for each container in the tier immediately under the top tier container, whether or not the container title includes the identification information registered to a registration unit and indicating that the container is of a first category; the registration unit to which identification information is registered in advance, the identification information being for indicating that a category of a container is the first category and
displaying a list of one or more containers in the tier immediately under the container whose title includes the identification information indicating that the container is of the first category in a display device, without displaying a list of the one or more containers in the tier immediately under the top tier container in the display device.
